(19) United States
(12) Patent Application Publication
(10) Pub. No.: US 2014/0280954 A1
(43) Pub. Date: Sep. 18, 2014

(54) Automated Processing of Data Plan Offers for Wireless Communication Networks

(71) Applicant: T-MOBILE USA, INC., Bellevue, WA (US)

(72) Inventor: Jingdong Yu, Bellevue, WA (US)

(73) Assignee: T-MOBILE USA, INC., Bellevue, WA (US)

(21) Appl. No.: 13/828,271

(22) Filed: Mar. 14, 2013

(51) Int. Cl. H04L 12/24

(52) U.S. Cl. CPC H04L 41/5041
USPC 709/226

(57) ABSTRACT

Systems and techniques for automated provisioning of a new data plan for use with a mobile device operating within a wireless communication network. Parameters for a data plan for use with a mobile device operating within a wireless communication network are received at a node of a computing system. Based upon the parameters, the data plan is automatically provisioned by the computing system. The data plan is then offered to subscribers within the wireless communication network.

### BACKGROUND

In recent years, telecommunication devices have advanced from offering simple voice calling services to providing users with many features. Telecommunication devices now provide many services that involve the transfer of data over wireless communication networks. These services include, for example, messaging services such as email, text messaging, and instant messaging; data services such as Internet browsing; media services such as storing and playing a library of favorite songs; location services; and many others. Providers of wireless communication network services generally offer various data plans to users of communication devices that offer a price per unit of data, lump sum price for a predetermined amount of data, etc.

Often providers of wireless communication network services will change data plan offerings. This can involve changing the type of plan, pricing, amount of data, etc. Providers of wireless communication network services will also often offer special data plans with special pricing to entice new subscribers to subscribe to a particular wireless communication network. The process of developing and provisioning new data plan offers is generally performed manually and thus, is labor intensive and time consuming, which can lead to long delays in offering new data plans.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates a network for providing, managing and operating data plans within a wireless communication network, in accordance with various embodiments.

FIG. 2 illustrates an automated data plan provisioning diagram, in accordance with various embodiments.

FIG. 3 is a flow diagram illustrating an example of automated provisioning of a new data plan, in accordance with various embodiments.

FIG. 4 is a flow diagram illustrating another example of automated provisioning of a new data plan, in accordance with various embodiments.

### DETAILED DESCRIPTION

Described herein are systems and techniques for automated provisioning of data plan offers for mobile devices being used in wireless communication networks. The data plan offers are developed and provided to a node of a computing system that configures a data plan management system for the wireless communication network service provider.

In an embodiment, a marketing department of the wireless communication network service provider generally comes up with data plans that provide pricing for use of data within the wireless communication network. For example, the data plans can enable a broadband experience on mobile computing devices within the wireless communication network. Such data plans can be prepaid or can be priced based upon usage. The data plans allow subscribers to use devices such as, for example, mobile phones, data sticks, tablets, etc., to access data via the wireless communication network using the data plan. Prepaid pricing plans can enhance the user experience by providing new competitive offers for a week, a month, etc., enable and remove 30-day auto-renewal for prepaid monthly plans, offer device-specific offers and restrict service to the MSISDN/device pairing used at the time of activation, offer devices with data-included trial offers, offer a day pass for an amount of data, offer data “top-up” offers for month pass and recurring trials, improve email notifications to customers, extend notifications via SMS to handsets, improve the web experience to ensure efficient purchase flows, and provide a better interface for payment.

In general, the data plan offer initiated by the marketing department is provided to a computing system within the wireless communication network. The request process X (RPX) node (where X can refer to multiple processes) that receives the parameters of the new data plan offer provides the parameters to a real time profile manager (RTPM) of a data usage metering solution (DUS) within the computing system. The RTPM maps the parameters to proper plan counter attributes and stores them in a unified subscriber database (USD). The RTPM will set up other aspects of the DUS such as, for example, the rating group, short message service (SMS) content, throttle thresholds, event notification, intelligent network (IN) real time charging flag (for deducting charges from a prepaid plan based on data usage), etc. The RPX node will also update a policy and charging rules function (PCRF) of the computing system. The PCRF performs the functions of dynamic control policy and charging characteristics for a data subscriber.

Once the PCRF and DUS are configured and properly updated for the new plan offer, the RPX node provisions a test of the offer with a “test” mobile device via the NSN application publisher (NAP), which is a data profile provisioning system. The NAP processes the test mobile device and updates the DUS/PCRF. The mobile device is tested for a user experience and upon completion, the new data plan is activated within the wireless communication network and available to be offered for sale within the network.

### Example Data Plan Network

FIG. 1 illustrates an example of a network 100 for provisioning, managing and operating data plans within a wireless communication network. The network 100 includes a request process X (RPX) node 102, an enterprise service platform (ESP) node 104, a data usage metering solution (DUS) node 106, a unified subscriber database (USD) 108, a NSN application publisher (NAP) 110 and a policy and charging rules function (PCRF) 112. The network 100 also includes a gateway GPRS support (GGSN) 114, where GPRS refers to General Packet Radio Service and a charge control node/intelligent network node (CCN/IN) 116, where the IN is a pre-paid charging system. The DUS node 106 generally includes an account management function (AMF) 118 and a real time profile manager (RTPM) 120.

A new data plan that a provider of services within a wireless communication network wishes to offer is developed and prepared by, for example, a marketing department of the provider. The parameters of the new data plan are provided by the marketing department to the RPX node 102 for automated provisioning within the network 100. The RPX node 102 provides the parameters of the new data plan to the RTPM 120 of the DUS node 106. This can be done, for example, utilizing simple object access protocol (SOAP). The RPX represents the billing function and source of the data plan. The billing function can be, for example, a prepaid billing function.

As noted, the RPX node 102 sends all required parameters for the new data plan to the RTPM node 120 of the DUS node 106. The RTPM 120 maps the parameters of the new data plan to proper data plan counter attributes and stores them in the USD database 110. The current DUS system configuration data and/or parameters for existing data plans are saved in multiple places and files within the network 100. For example, the configuration data and/or parameters for existing data plans can be moved to the USD database so that the automatic provisioning of the new data plan can take effect without impacting the current services provided for other data plans.

The RTPM 120 is the new data plan's provisioning access point and in addition to the counter attribute profile mapping, the RTPM 120 also sets up other configurations of the DUS 106 such as the account management function (AMF) 118. Such configuration can include, for example, a rating group, SMS content, throttle thresholds, event notification, IN real time charging flag (for deducting charges from a prepaid plan based on data usage), etc. If the new data plan does not need many dynamic charging rates on the DUS 106, then some pre-defined charging characteristics may be able to satisfy most of the new data plan's requirements, including a free/paid rating group and real time charging rating group (need IN credit deduction). Such pre-defined rating groups need to be agreed and in sync across the PCRF 112, DUS 106, GGSN 114, and CCN/IN 116.

The PCRF 112 performs the functions of dynamic control of policy and charging characteristics for a data subscriber. Thus, the PCRF 112 is generally the network's policy controller. The PCRF 112 supports various functions including, for example, on request of the GGSN 114, the PCRF provides policy and charging rules appropriate for the data subscription of the data plan. Additionally, the PCRF 112 allows flexible derivation of rules, using dynamic data like location, the subscriber's roaming situation, the subscriber's device-type, etc. The PCRF 112 also provides a quality of service (QoS) policy based on the user profile of the data subscriber and the packet data protocol (PDP) context. Additionally, the PCRF 112 can provide user PDP session information to third-party applications.

The PCRF's system configuration related to existing data plans is generally moved to the USD database 110. The RTPM 120 then modifies the appropriate data in the USD database to change the PCRF 112 system configuration based upon the parameters of the new data plan. The PCRF 112 maps different new data plan parameters to redefine charging rule base names (i.e., the rules that the GGSN 114 is able to support). The primary difference of different data plans will be relevant to the DUS 106 for different data plan “bucket” sizes (i.e., an amount of data), throttle thresholds, etc.

The GGSN 114 provides interworking with packet data networks and is coupled to the serving GPRS support node (SGSN)s via an internet protocol based (IP-based) backbone network. In order for a user's mobile device to send and receive packets via a GPRS, the user will activate a PDP context that will make it known in the GGSN 114 and interworking with the data networks can commence. The user data is transferred directly between the mobile device and the GGSN 114 through the intermediated GPRS nodes (base station controller and SGSN) via encapsulation and tunneling. During a data session, the GGSN 114 requests data from the DUS 106 and meters the subscriber data usage. When requested quota of data is depleted, the GGSN 114 requests more quota of data from the DUS 106 and reports the consumed data to the DUS 106, i.e. the AMF 118. Therefore, the GGSN 114 is configured to support various rating groups based upon the various data plans.

The CCN/IN 116 includes an IN, which represents a real time charging system. The CCN is the front end to accept credit requests from the DUS 106. Once again, the CCN/IN 116 is configured to support the various known rating groups for the different data plans. The CCN/IN 116 can communicate with the DUS 106 via security context automation protocol (SCAP).

The NAP 110 is the user provisioning gateway for data service. Since various data plans are unique, each data plan is generally made transparent on NAP to support new data plans, which means the NAP 110 is generally not concerned about new data plan names and does not need to implement mapping for them. The NAP 110 generally simply passes the data plan information to the RTPM 120 and the PCRF 112 during user provisioning.

The nodes and functions described herein can generally be implemented with various computing devices, firmware and software. A single computing device or multiple computing devices can be used.

Example Provisioning of New Data Plan within the Network

FIG. 2 illustrates an automated data plan provisioning diagram. A new data plan offer provisioning query is received from the RPX 102 at the RTPM 120 of the data usage metering solution (DUS) 106. The query includes the various parameters for the new data plan. The parameters of the data plan are loaded into a data metering (DM) loader 202 in a template created by an application programming interface (API) handler 204. The template with the various parameters of the new data plan is also provided to a policy and charging rules function (PCRF) loader 206.

The DM loader 202 can be software or firmware that takes the template with the parameters of the new data plan that are related to data metering and loads the parameters into a data metering (DM) node 212 of the DUS 106, as will be discussed further herein. The DM loader 202 also loads the parameters of the new data plan that are related to data metering into a data plan catalog 208 of the USD 110. The data plan catalog 208 stores the various parameters for various data plans, including configuration data and parameters for new and existing data plans.

The PCRF loader 206 can be software or firmware that takes the template with the parameters of the new data plan that are related to a policy and charging rules function of the new data plan and loads the parameters into a PCRF configuration database 210 of the USD 110. The PCRF loader 206 also takes the template with the parameters of the new data plan that are related to the policy and charging rules function of the new data plan and loads the parameters into the data plan catalog 208 of the USD 110. The PCRF loader 206 also provides the parameters of the new data plan related to the policy and charging rules function of the new data plan to the PCRF 112 of FIG. 1, which serves as the policy controller of the network 100.

The API handler 204 creates and provides the template with the various parameters of the new data plan to the DM loader 202 in a manner that allows the DM loader 202 to properly communicate with the data metering node 212 of the DUS 106 and the data plan catalog 208 of the USD 110. The API handler 204 also creates and provides the template with the various parameters of the new data plan to the PCRF loader 206 that allows the PCRF loader 206 to properly communicate with the PCRF configuration database 210 of the USD 110 and the data plan catalog 208 of the USD 110.

More particularly, the DM loader 202 loads the template with the parameters of the new data plan that are related to data metering into the DM node 212 of the DUS 106, which includes the account management function (AMF) 118, as well as a session-based charging function (SBCF) and a rating function (RF) 214. The AMF 118 can be software or firmware that manages an account related to a mobile device. The SCBF/RF 214 can be software or firmware that manages charges for an account related to a mobile device. The charges can be session based, e.g., based on session length, rate based, e.g., rate per unit of time, rate per unit of data used, or a combination of both. Additionally, the various parameters of the new data plan related to data metering are stored within a DM configuration database 216 of the DM node 212. The stored parameters can be used to configure various aspects of data metering within the network 100 based upon a data plan, including the new data plan.

The PCRF loader 206 utilizes parameters from the template to load the parameters to the PCRF configuration database 210 of the USD 110. As previously noted, the PCRF 112 performs the functions of dynamic control of policy and charging characteristics for a data subscriber. Thus, the PCRF 112 is generally the policy controller of the network 100. Since the PCRF 112 supports various functions including, for example, on request of the GGSN 114, providing policy and charging rules appropriate for the data subscription of a data plan, the PCRF configuration database 210 uses the loaded parameters of the new data plan to configure the PCRF 112. The PCRF 112 allows flexible derivation of rules, using dynamic data like location, the subscriber's roaming situation, the subscriber's device-type, etc. The PCRF 112 also provides a quality of service (QoS) policy based on the user profile of the data subscriber and the packet data protocol (PDP) context. Additionally, the PCRF 112 can provide user PDP session information to third-party applications. The PCRF configuration database 210 of the USD 110 uses the stored parameters of data plans to configure the PCRF 112 accordingly for data plans, including the new data plan.

The template may be passed among the various nodes via, for example, a lightweight directory access protocol (LDAP).

As a final step of the provisioning process, referring back to FIG. 1, once the various nodes and functions have been updated and properly configured for the new data plan, a “test” mobile device 122 is provisioned with the new data plan by the RPX 102. The provisioning test of the test mobile device 122 can be performed by, for example, using a simulation tool, by having a user try to sign up for and/or use the new data plan, etc. The ID of the test mobile device is processed by the NAP 110, which updates the DUS 106 and the PCRF 112 for the test mobile device. The test mobile device is analyzed by a person for a user experience in order to determine that the new data plan works properly. Upon determination that the new data plan works properly, then the new data plan is activated and offered for sale by the provider within the provider's wireless communication network.

The automated process in accordance with the present disclosure can be accomplished in several hours and thus, saves time. The automated process allows for new data plans to be offered by a services provider very quickly and efficiently.

### Example Processes

FIG. 3 is a flow diagram illustrating an example of automated provisioning of a new data plan. At 304, parameters for a data plan for use with a mobile device operating within a wireless communication network are received at a node of a computing system. At 308, based upon the parameters, the data plan is automatically provisioned by the computing system. At 312, the data plan is offered to subscribers within the wireless communication network.

FIG. 4 is a flow diagram illustrating another example of automated provisioning of a new data plan. At 404, parameters for a data plan for use with a mobile device operating within a wireless communication network are received at an RPX node of a computing system. At 408, the parameters of the data plan are forwarded from the RPX node to a real time profile manager (RTPM) of a data usage metering solution (DUS) of the computing system. At 412, the parameters of the data plan are mapped to attributes of a provider of services within the wireless communication network mapping, by the RTPM. At 416, based upon the parameters of the data plan, the DUS is configured by the RTPM. At 420, a policy and charging rules function (PCRF) of the computing system is updated by the RPX node via the RTPM. At 424, a provisioning test of the data plan is performed by the RTPM.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

I claim:

1. A method comprising:
receiving, at a node of a computing system, parameters for a data plan for use with a mobile device operating within a wireless communication network;
based upon the parameters, automatically provisioning, by the computing system, the data plan; and
offering, by the computing system, the data plan to subscribers within the wireless communication network.

2. The method of claim 1, wherein automatically provisioning comprises automatically mapping parameters of the data plan to a data usage metering solution of the computing system and storing the parameters in a database.

3. The method of claim 2, further comprising storing parameters of at least one existing data plan in the database.

4. The method of claim 2, wherein automatically provisioning further comprises automatically updating a policy and charging rules function of the computing system.

5. The method of claim 2, wherein automatically mapping parameters of the data plan to a data usage metering solution comprises mapping the parameters to a real time profile manager of the data usage metering function.

6. The method of claim 5, wherein automatically mapping parameters of the data plan to a data usage metering solution further comprises updating an account management function of the data usage metering solution.

7. The method of claim 1, further comprising performing a provisioning test of the data plan.

8. A system comprising:
a tangible storage medium; and
instructions stored in the tangible storage medium, the instructions being executable by the system to
receive, at a node of the system, parameters for a data plan for use with a mobile device operating within a wireless communication network;
automatically provision the data plan; and
offer the data plan to subscribers within the wireless communication network.

9. The system of claim 8, wherein automatically provisioning comprises automatically mapping parameters of the data plan to a data usage metering solution of the system and storing the parameters in a database.

10. The system of claim 9, wherein the instructions are further executable by the apparatus to store parameters of at least one existing data plan in the database.

11. The system of claim 9, wherein automatically provisioning further comprises automatically updating a policy and charging rules function of the system.

12. The system of claim 9, wherein automatically mapping parameters of the data plan to a data usage metering solution comprises mapping the parameters to a real time profile manager of the data usage metering function.

13. The system of claim 12, wherein automatically mapping parameters of the data plan to a data usage metering solution further comprises updating an account management function of the data usage metering solution.

14. The system of claim 8, further comprising performing a provisioning test of the data plan.

15. A method comprising:
receiving, at a request process X (RPX) node of a computing system, parameters for a data plan for use with a mobile device operating within a wireless communication network;
forwarding, from the RPX node to a real time profile manager (RTPM) of a data usage metering solution (DUS) of the computing system, the parameters of the data plan;
mapping, by the RTPM, the parameters of the data plan to attributes of a provider of services within the wireless communication network;
based upon the parameters of the data plan, configuring, by the RTPM, the DUS;
updating, by the RPX node via the RTPM, a policy and charging rules function (PCRF) of the computing system; and
performing, by the RTPM, a provisioning test of the data plan.

16. The method of claim 15, wherein configuring, by the RTPM, the DUS node comprises mapping parameters of the data plan to the DUS and storing the parameters in a database.

17. The method of claim 16, further comprising storing parameters of at least one existing data plan from the DUS into the database.

18. The method of claim 16, wherein configuring, by the RTPM, the DUS comprises mapping the parameters to the RTPM of the DUS.

19. The method of claim 18, wherein configuring, by the RTPM, the DUS further comprises updating an account management function of the DUS.

20. The method of claim 15, further comprising offering the data plan to subscribers within the wireless communication network.
